(19) United States
(12) Patent Application Publication
(10) Pub. No.: US 2007/0289273 A1
(43) Pub. Date: Dec. 20, 2007

(54) Air filter with pleat lock

(76) Inventor: Kevin E. Boyd, (US)

Correspondence Address: NIXON PEABODY, LLP, 401 9TH STREET, NW, SUITE 900, WASHINGTON, DC, 20004-2128, US

(21) Appl. No.: 11/454,011

(22) Filed: Jun. 16, 2006

(51) Int. Cl. B01D 46/00

(52) U.S. Cl. 55/497

(57) ABSTRACT

An air filter with a pleated filter medium and a mechanism to keep the pleats in equal spacing and defined position. The air filter comprises a pleated filter medium, adhesively delimited to both sides in pleating direction by two U-shaped pleat-lock strips, which hold the pleats in place. The filter medium including the pleat-lock strips is covered with a die-cut frame that wraps around the two sides of the filter medium perpendicular to pleating direction. Alternatively, the pleat-lock strips may be planar and adhesively attached to the outside edges at suitable distances to the edges of the top side of the filter medium in pleating direction. The filter medium including the pleat-lock strips is case-like enclosed by two die-cut frame pieces, one on each side of the filter medium. One frame piece wraps the edges of the filter medium in pleating direction; the other one wraps the edges of the filter medium perpendicular to pleating direction. A method for assembling the pleated air filter is also included in the present invention.

### BACKGROUND OF THE INVENTION

1. Field of the Invention

The present invention relates generally to air filters and, more particularly, to an air filter with a pleated filter medium and a mechanism to keep the pleats in equal spacing and position.

2. Description of the Prior Art

Generally, prior art in the field of pleated air filters consists of devices which contain various elements to support the pleated structure of the filter medium. Commonly, a wire mesh metal sheet is pleated in the same way as the filter medium and used to support the filter across its entire surface. Modern examples of pleat fixating elements include saw-tooth spacers, thermoplastic reinforcement strips, and edge banding. Specific citations and brief abstract statements summarizing the main points for each prior art reference are as follows:

U.S. Pat. No. 5,1679,740 issued Dec. 1, 1992, to Michaelis, et al. for Method of making a filter insert of nonwoven material in the form of a pleated pack describes the manufacture of a self-supporting, pleated filter insert consisting of thermally weldable nonwoven. The flat filter material is pleated and drawn apart to produce defined pleat spacing. The two outside edges of the pleated pack are gripped between comb-like tools that hold the pleats in place. On both sides, the pleated pack is hemmed with projecting material of the nonwoven forming the pleats. In the hem, the nonwoven material is folded over and fixated to the adjacent pleat end, so that the edges overlap one another. The hem is finished by thermal welding under pressure.

U.S. Pat. No. 5,509,950 issued Apr. 23, 1996, to van de Graaf, et al. for Filter device for the filtration of gases and/or fluids describes a cartridge-like filter element with a pleated filter medium. The filter medium is provided with thermoplastic stabilizing strips bonded thereto on its two longitudinal sides extending in the pleating direction, for stabilizing the zig-zag-shaped pleated configuration.

U.S. Pat. No. 6,521,011 issued Feb. 18, 2003, to Sundet, et al. for Self-supporting pleated filter and method of making same describes a filter design and manufacturing process for a filter assembly including a pleated filter medium and pleat supporting members. At least one planar reinforcing strip oriented in the direction of pleating is bonded to the pleat tips on the front face of the filter medium. At least one reinforcing member is positioned along the rear face of the filter medium. Frame members are applied for some applications. The reinforcing member may be a reinforcing strip oriented in the direction of pleating and bonded to the rear face of the filter medium prior to the step of forming the pleats. A second planar reinforcing strip may optionally be bonded to the reinforcing strip pleat tips. The reinforcing member, the first reinforcing strip and the second reinforcing strip can be aligned to form a truss structure. Alternatively, reinforcing strips oriented perpendicular to the direction of pleating are bonded to the rear face of the filter medium prior to the step of forming the pleats.

U.S. Pat. No. 6,846,342 issued Jan. 25, 2005 (formerly Application No. 2004006566), to Mertz, et al. for Filter pack having nonwoven filter media and nonwoven edge banding frame describes a filter pack of a pleated filter section and a top edge band and a bottom edge band that form a frame. The filter section and the frame are formed of a nonwoven polymer material, preferably a polyester material. The filter section is retained in the frame by an adhesive, preferably also a polyester material. The filter pack is fully shreddable and does not require separation into various components for recycling.

U.S. Patent Application No. 20050150201 issued Jul. 14, 2005, to Choi, et al. for Crest supported filter frame assembly and method describes a fluid pleated filter assembly arrangement. The sharp and narrow crests of the pleated medium are enhanced by alignment of the fibers with the direction of fluid stream flow, with the crests being supported by a preselectively controlled breadth and thickness support strip and adhesive fastening band disposed intermediate opposed side edges of the support strip.

None of the prior art contains a pleated air filter with simple, yet efficient, means of holding the pleats of the nonwoven filter medium in place. Pleated nonwoven filter medium are generally rigid perpendicular to the filter plane, so that under pressure of the incoming fluid flow, the pleats will not collapse. However, with non-uniform flow across the entire filter plane, pleats tend to shift towards lower pressure areas, resulting in pleat and filter deformation and reduced filter life and efficiency. Therefore, a simple, cost-effective means of holding the pleats in place, which can easily be integrated in the filter manufacturing process, is desired. This means will increase the filter life and efficiency compared to unsupported, pleated, or unpleated planar air filters, and reduce the manufacturing cost compared pleated filters with traditional pleat support means such as metal rims or framing spacers, while providing similar pleat spacing stability.

Thus, there remains a need for a pleated planar air filter with a simple mechanism to keep the pleats equally spaced and in defined position, furtherin referred to as pleat-lock.

### SUMMARY OF THE INVENTION

The present invention is directed to an air filter with a pleated filter medium and a mechanism to keep the pleats in equal spacing and defined position. This pleat spacing mechanism is furtherin referred to as pleat-lock.

In a preferred embodiment, the air filter comprises a pleated filter medium, adhesively delimited to both sides in pleating direction by two U-shaped pleat-lock strips that hold the pleats in place. The pleat-lock strip may be of rigid cardboard or other suitable material. The filter medium including the pleat-lock strips is covered with a die-cut frame that wraps around the two sides of the filter medium perpendicular to pleating direction.

In an alternative embodiment, the air filter comprises a pleated filter medium, with two planar pleat-lock strips adhesively attached to the outside edges of the top side of the filter medium in pleating direction. The filter medium including the pleat-lock strips is enclosed by two die-cut frame pieces, one on each side of the filter medium, and one wrapping the edges of the filter medium in pleating direction, the other one wrapping the edges of the filter medium perpendicular to pleating direction.

In yet an alternative embodiment, the air filter comprises a pleated filter medium, with at least two planar pleat-lock strips adhesively attached to the top side of the filter medium in pleating direction, at suitably selected distances to the edges of the medium in pleating direction. The filter medium including the pleat-lock strips is enclosed by two die-cut frame pieces, one on each side of the filter medium, and one wrapping the edges of the filter medium in pleating direction, the other one wrapping the edges of the filter medium perpendicular to pleating direction.

The present invention is further directed to a method for assembling the pleated air filter. These and other aspects of the present invention will become apparent to those skilled in the art after a reading of the following description of a preferred embodiment when considered with the drawings.

### BRIEF DESCRIPTION OF THE DRAWINGS

FIG. 1 is a perspective, exploded view of the filter frame in a first preferred form.

FIG. 2 is a top view of the planar, pleated filter in the first preferred form.

FIG. 3 is a bottom view of the planar, pleated filter in the first preferred form.

FIG. 4 is a cross-sectional view at the line 4-4 in FIG. 2 of the filter perpendicular to pleating direction.

FIG. 5 is a cross-sectional view at the line 5-5 in FIG. 2 of the filter in pleating direction.

FIG. 6 is a perspective, exploded view of the filter frame in a second embodiment.

FIG. 7 is a top view of the planar, pleated filter in the second embodiment.

FIG. 8 is a bottom view of the planar, pleated filter in the second embodiment.

FIG. 9 is a cross-sectional view at the line 9-9 in FIG. 7 of the filter perpendicular to pleating direction.

FIG. 10 is a cross-sectional view at the line 10-10 in FIG. 7 of the filter in pleating direction.

FIG. 11 is a perspective, exploded view of the filter frame in a third embodiment.

FIG. 12 is a top view of the planar, pleated filter in the third embodiment.

FIG. 13 is a bottom view of the planar, pleated filter in the third embodiment.

FIG. 14 is a cross-sectional view at the line 14-14 in FIG. 12 of the filter perpendicular to pleating direction.

FIG. 15 is a cross-sectional view at the line 15-15 in FIG. 12 of the filter in pleating direction.

### DETAILED DESCRIPTION OF THE PREFERRED EMBODIMENTS

In the following description, like reference characters designate like or corresponding parts throughout the several views. Also in the following description, it is to be understood that such terms as “forward,” “rearward,” “front,” “back,” “right,” “left,” “upwardly,” “downwardly,” and the like are words of convenience and are not to be construed as limiting terms.

Referring now to the drawings in general, the illustrations are for the purpose of describing a preferred embodiment of the invention and are not intended to limit the invention thereto.

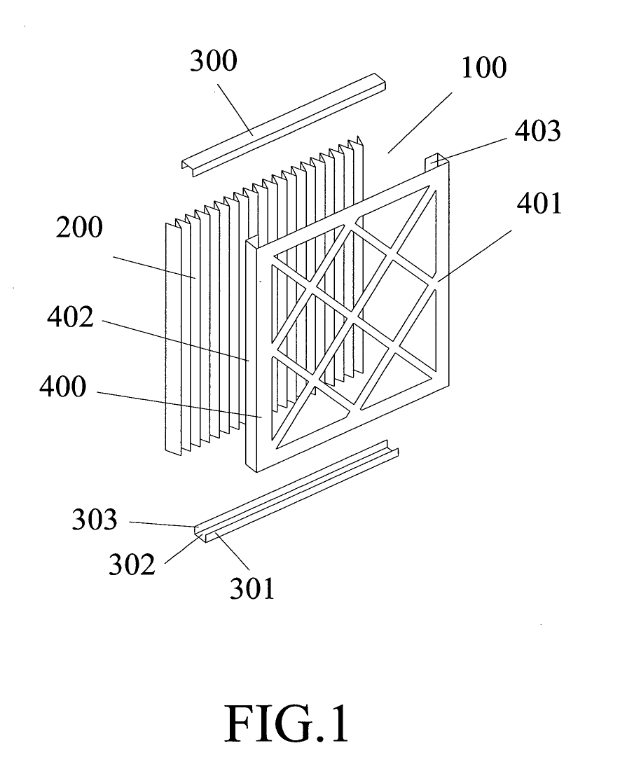

FIG. 1 shows the air filter in its preferred form, generally referred to as 100, in a perspective, exploded view. The pleated filter medium panel 200 is delimited to both sides in pleating direction by two U-shaped pleat-lock strips 300. Each pleat-lock strip has an upper face in pleating direction 301, a side face in pleating direction 302, and a lower face in pleating direction, 303. One side of the filter medium 200, furtherin referred to as the front, is covered by a webbed filter frame 400. A webbed filter frame is preferable to a non-webbed filter frame to provide enhanced filter strength. The filter frame is of the width of the filter medium 200 in pleating direction and wraps around the sides of the filter medium perpendicular to the pleating direction. The section of the filter frame covering the filter medium is designated as upper face of the filter frame 401. Preferably, on each side of the filter medium, perpendicular to the pleating direction, the frame continues with two side faces 402 and two lower faces 403, which are folded back underneath the opposite side of the filter medium. Alternatively, the filter frame may have four side faces; the two additional side faces (not shown) wrap around the pleat-lock strips 300 to provide enhanced frame strength and rigidity.

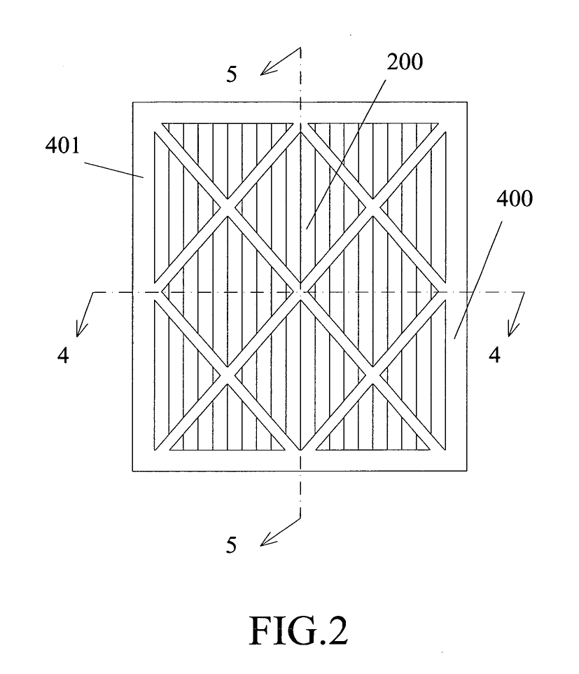

FIG. 2 shows a top view of the filter 100. The pleated filter medium 200 is covered by the upper face of the filter frame 401.

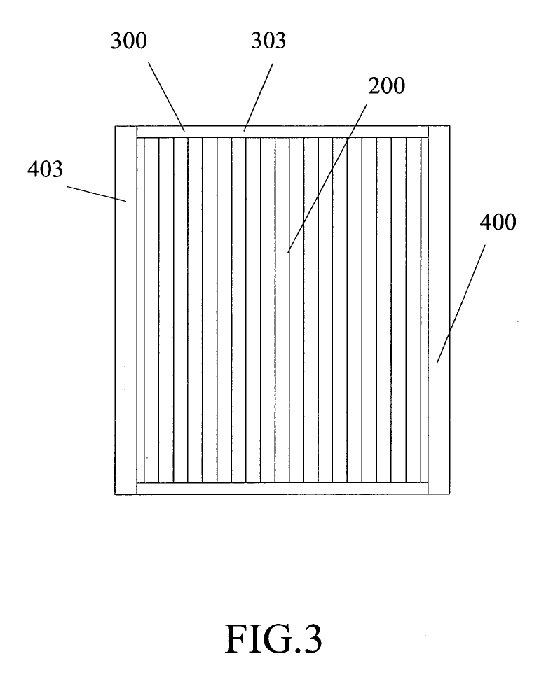

FIG. 3 shows a bottom view of the filter 100. Each outer edge of the filter medium in pleating direction is covered by a lower face of a pleat-lock strip 303. Each outer edge of the filter medium perpendicular to the pleating direction is covered by a lower face of the filter frame 403.

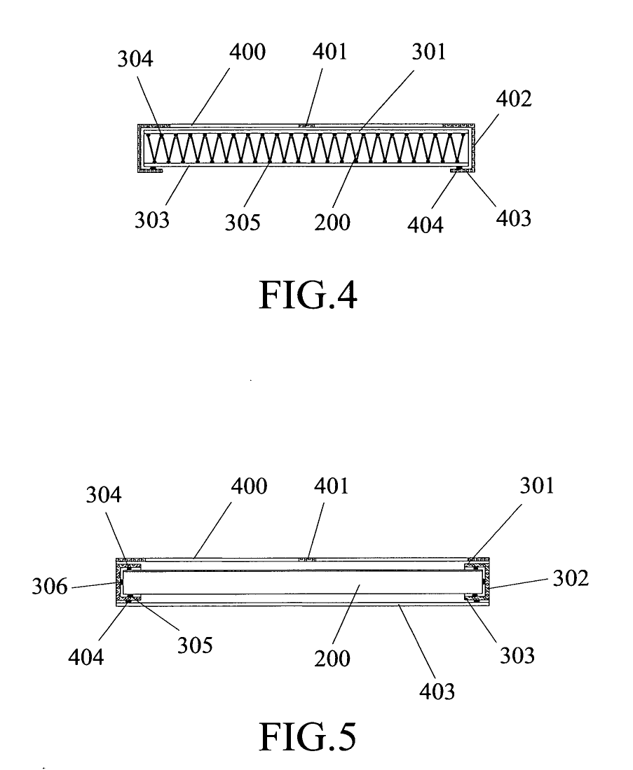

FIG. 4 shows the cross-sectional view of the filter along the line 4-4 in FIG. 2. The upper and the lower face of the pleat-lock strip 301 and 303 enclose the filter medium 200 from behind in view direction, and are adhesively connected to the pleat tips of the filter medium with the adhesive on the top side and the bottom side of the filter medium panel 304 and 305. As a result, the pleat-lock strips hold the pleats of the filter medium in place, prevent shifting of the pleats in pleating direction, and keep the distance between pleats constant and approximately equivalent. The cross-section also shows how the filter frame 400 is wrapped around the filter perpendicular to the pleating direction, with an upper face on the top side of the filter medium 401, side faces 402 and lower faces 403. The lower faces of the filter frame 403 are adhesively connected in each bottom corner of the filter medium with adhesive 404 to the lower faces of the pleat-lock strips 303. Alternatively, during manufacturing, adhesive may be applied to completely cover the filter frame on the filter medium side.

FIG. 5 is a cross-sectional view of the filter along the line 5-5 in FIG. 2. It is shown how the upper and the lower face of the filter frame 401 and 403 enclose the filter medium and the pleat-lock strips perpendicular to pleating direction. Each pleat-lock strip 300 is attached by means of adhesive to the upper and lower tips of the pleats in the peripheral area of the filter medium. The side face of the pleat-lock strip 302 is also adhesively attached to the open edges of the filter medium in pleating direction, aiding to prevent shifting of pleats as well as collapsing of pleats. The adhesive between the top face of the pleat-lock strip and the upper tips of the filter pleats is denoted as 304, the adhesive between the side face of the pleat-lock strip and the open edges of the filter medium is denoted as 306, and the adhesive between the bottom face of the pleat-lock strip and the lower tips of the filter pleats is denoted as 305. Alternatively, the adhesive may be only applied such that it only covers part of the pleat-lock strips.

In another embodiment, adhesive may be used to secure the filter frame 400 to the pleat tips of the filter medium on its upper face, its lower face or/and its side face in addition to the places where adhesive is used as denoted in the drawings.

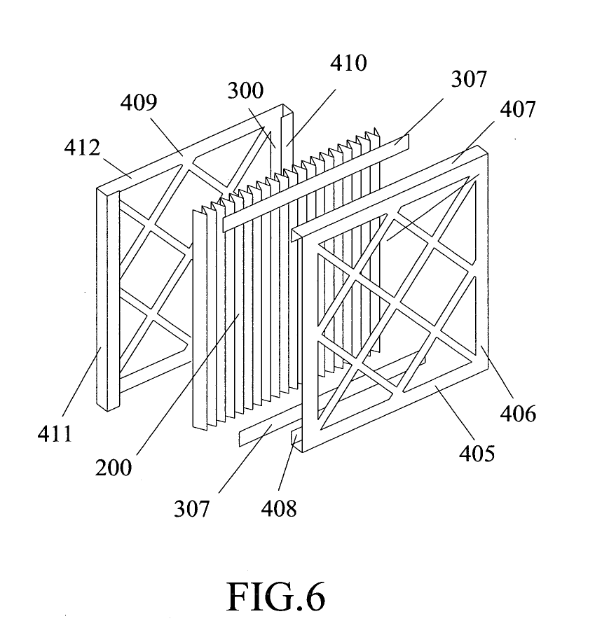

FIG. 6 shows the air filter in a second embodiment, generally referred to as 101, in a perspective, exploded view. Two pleat-lock strips 307 are attached by means of adhesive at the outside edges of one face of the filter medium panel 200 along the pleating direction. The pleat-lock strips 307 are flat bands of a rigid cardboard or other suitable material. Alternatively, the pleat-lock strips may be attached to the sides of the pleated filter medium panel 200. Upper and a lower complementary filter frame portions 405 and 409 enclose the filter medium including the pleat-lock strips. The top filter frame portion consists of an upper face 406, two side faces 407 and two lower faces 408. The top filter frame portion 405 covers the top plane of the filter medium and wraps around the open pleat ends in direction of pleating, with its top face 406, the side faces 407, and its bottom faces 408 forming U-shaped channels to accommodate the filter pleats. The bottom filter frame portion 409 consists of a lower face 412, two side faces 411 and two upper faces 410. The bottom filter frame portion 409 covers the lower plane of the filter medium and wraps around the peripheral filter pleat perpendicular to pleating direction, with its top faces 410, the side faces 411, and its bottom face 412 forming a U-shaped channel to accommodate the height of the filter medium. Alternatively, the upper and lower filter frame portions may have four side faces each to enhance the frame's strength and rigidity. Alternatively, the upper frame portion may have four sides and the lower frame portion can be eliminated to decrease weight and manufacturing costs.

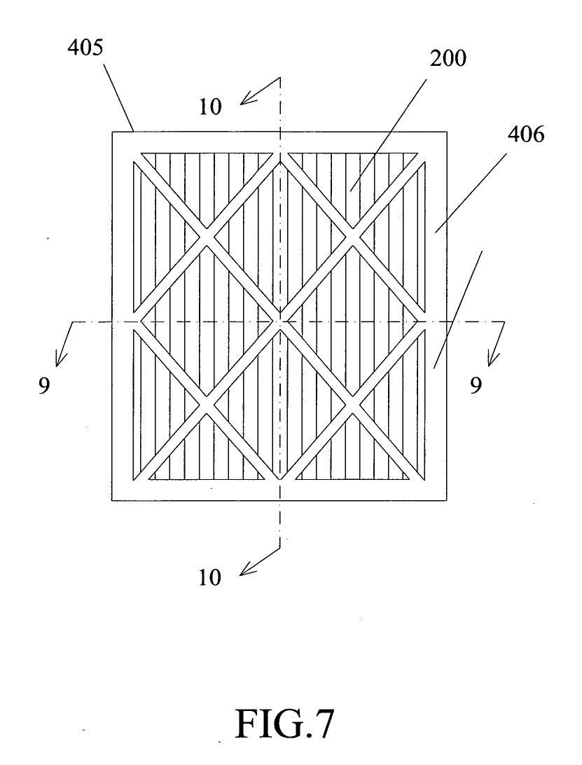

FIG. 7 shows a top view of the filter 101. The pleated filter medium 200 is covered by the upper face of the upper filter frame portion 406.

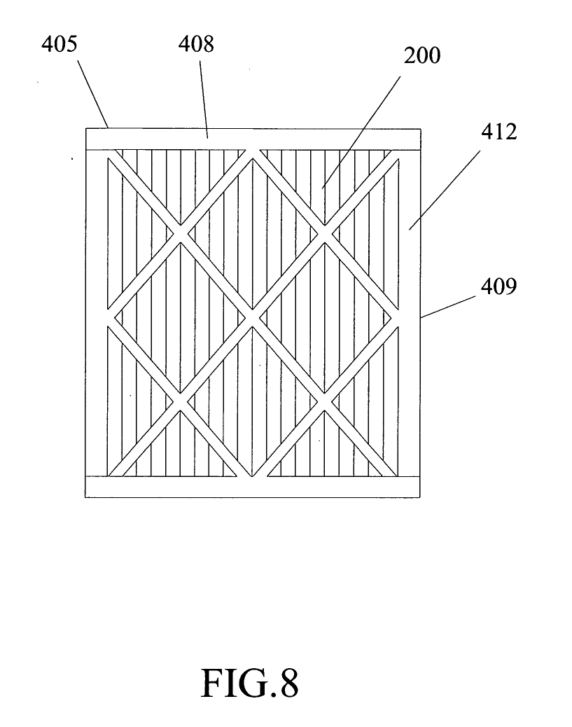

FIG. 8 shows a bottom view of the filter 101. The pleated filter medium 200 is covered by the lower face of the lower filter frame portion 410. At the peripheral edges of the filter medium in pleating direction, the upper filter frame portion is folded around the pleat edges and back underneath the edge of the lower frame portion in a U-shaped manner, so that the lower face of the upper frame portion 408 is visible on the lower face of the filter.

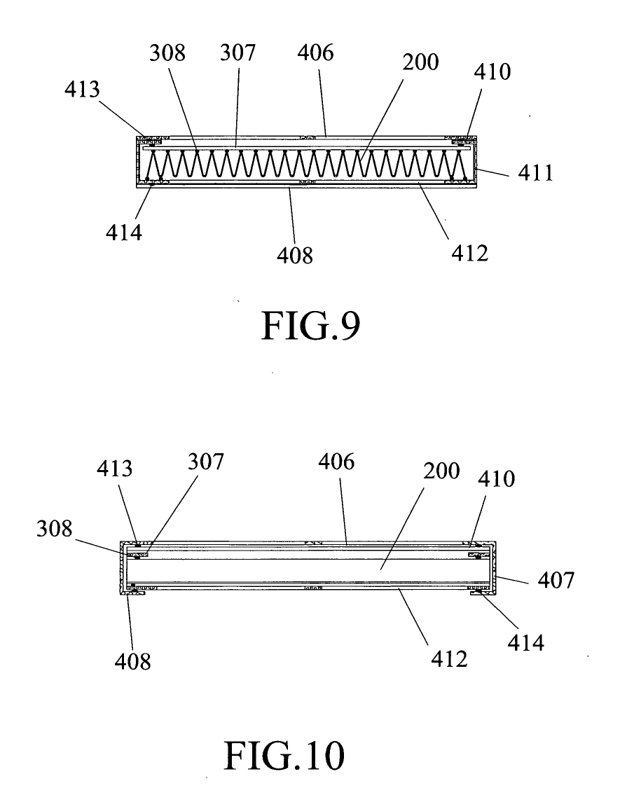

FIG. 9 shows the cross-sectional view of the filter along the line 9-9 in FIG. 7. Each pleat-lock strip 307 is attached to the upper pleat tips of the filter medium 200 by means of adhesive 308. As a result, the pleat-lock strips hold the pleats of the filter medium in place, prevent shifting of the pleats in pleating direction, and keep the distance between pleats constant and approximately equivalent. The cross-section also shows how the upper filter frame portion 405 is wrapped around the filter perpendicular to the pleating direction, with an upper face on the top side of the filter medium 406, side faces 407 as shown in FIG. 10, and lower faces 408. The lower filter frame portion 409 is wrapped around the filter in pleating direction, with its upper faces 410, side faces 411, and lower faces 412 wrapping around the longitudinal sides of the filter medium.

FIG. 10 is a cross-sectional view of the filter along the line 10-10 in FIG. 7. From FIG. 9 and FIG. 10 it is visible how the upper and the lower frame portion are attached to each other by means of adhesive at the filter periphery on the upper side in pleating direction 413 and on the lower side perpendicular to pleating direction 414 to form a closed casing for the filter.

In another preferred embodiment, adhesive may be used to secure the upper filter frame portion 405 to the pleat tips of the filter medium on its upper face, or/and to the pleat-lock strips 307 in addition to the places where adhesive is used as denoted in the drawings. Furthermore, adhesive may be used to secure the lower filter frame portion 409 to the pleat tips of the filter medium on its lower face, in addition to the places where adhesive is used as denoted in the drawings.

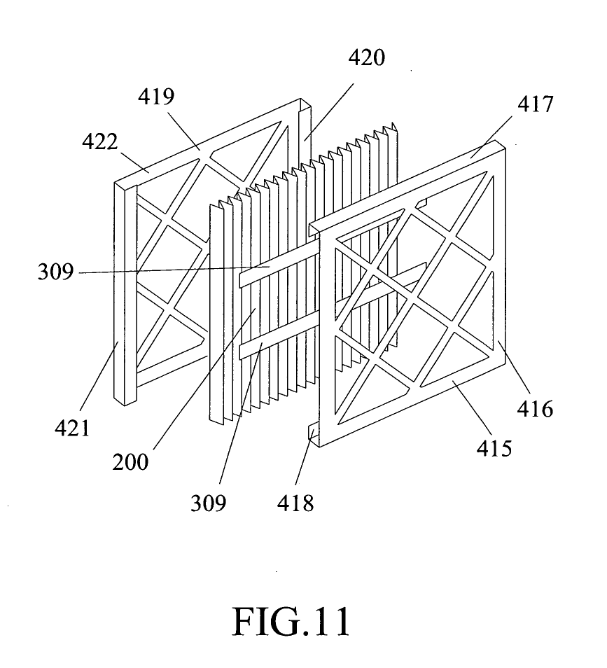

FIG. 11 shows the air filter in a third embodiment, generally referred to as 102, in a perspective, exploded view. At least two pleat-lock strips 309 are attached by means of adhesive at suitable locations on one face of the filter medium panel 200 in pleating direction. The pleat-lock strips 309 are flat bands of a rigid cardboard or other suitable material. An upper and a lower complementary filter frame portion 415 and 419 enclose the filter medium including the pleat-lock strips. The top filter frame portion consists of an upper face 416, two side faces 417 and two lower faces 418. The top filter frame portion 415 covers the top plane of the filter medium and wraps around the open pleat ends in direction of pleating, with its top face 416, the side faces 417, and its bottom faces 418 forming U-shaped channels to accommodate the filter pleats. The bottom filter frame portion 419 consists of a lower face 422, two side faces 421 and two upper faces 420. The bottom filter frame portion 419 covers the lower plane of the filter medium and wraps around the peripheral filter pleat perpendicular to pleating direction, with its top faces 420, the side faces 421, and its bottom face 422 forming a U-shaped channel to accommodate the height of the filter medium. Alternatively, the upper and lower filter frame portions may have four side faces each to enhance the frame's strength and rigidity.

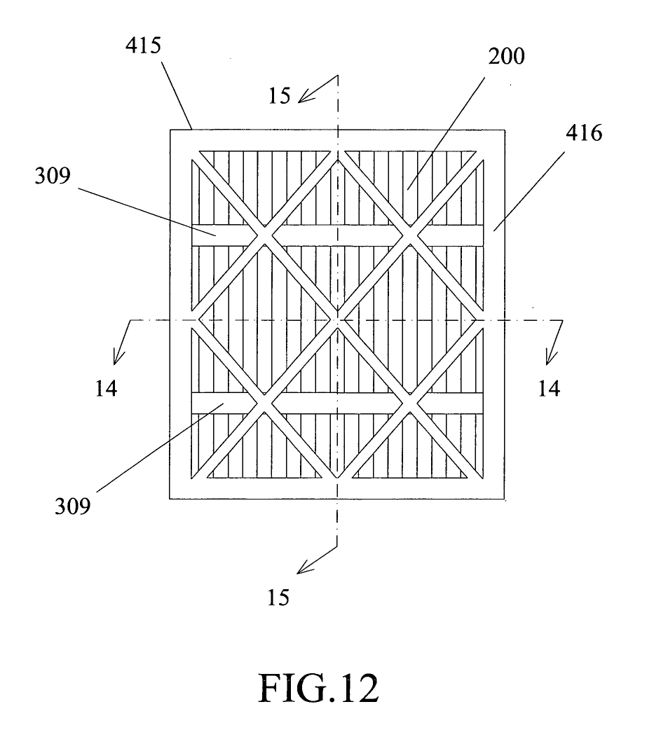

FIG. 12 shows a top view of the filter 102. The pleated filter medium 200 is covered by the upper face of the upper filter frame portion 416.

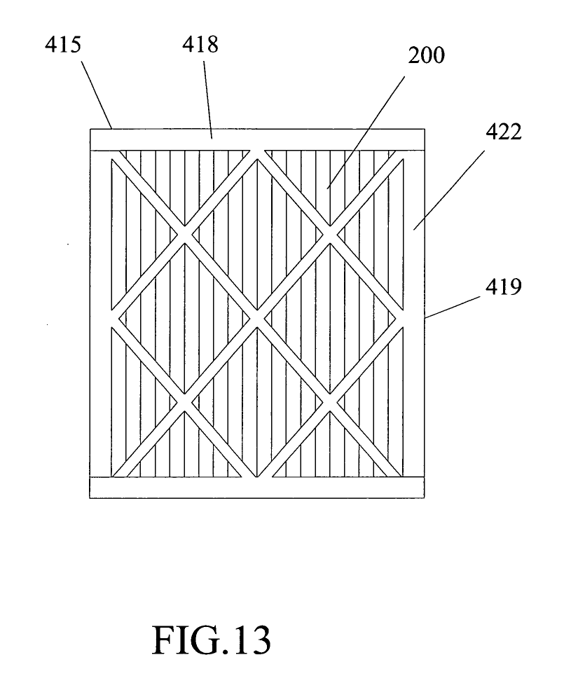

FIG. 13 shows a bottom view of the filter 102. The pleated filter medium 200 is covered by the lower face of the lower filter frame portion 420. At the peripheral edges of the filter medium in pleating direction, the upper filter frame portion is folded around the pleat edges and back underneath the edge of the lower frame portion in a U-shaped manner, so that the lower face of the upper frame portion 418 is visible on the lower face of the filter.

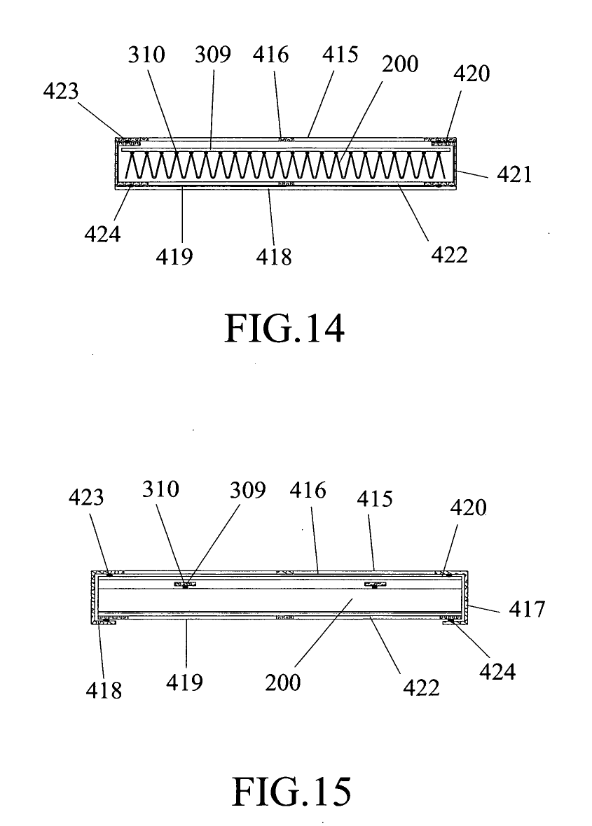

FIG. 14 shows the cross-sectional view of the filter along the line 14-14 in FIG. 12. Each pleat-lock strip 309 is attached to the upper pleat tips of the filter medium 200 by means of adhesive 310. As a result, the pleat-lock strips hold the pleats of the filter medium in place, prevent shifting of the pleats in pleating direction, and keep the distance between pleats constant and approximately equivalent. The cross-section also shows how the upper filter frame portion 415 is wrapped around the filter perpendicular to the pleating direction, with an upper face on the top side of the filter medium 416, side faces 417 as shown in FIG. 15, and lower faces 418. The lower filter frame portion 419 is wrapped around the filter in pleating direction, with its upper faces 420, side faces 421, and lower faces 422 wrapping around the longitudinal sides of the filter medium.

FIG. 15 is a cross-sectional view of the filter along the line 15-15 in FIG. 12. From FIG. 14 and FIG. 15 it is visible how the upper and the lower frame portion are attached to each other by means of adhesive at the filter periphery on the upper side in pleating direction 423 and on the lower side perpendicular to pleating direction 424 to form a closed casing for the filter.

In another embodiment, adhesive may be used to secure the upper filter frame portion 415 to the pleat tips of the filter medium on its upper face, or/and to the pleat-lock strips 309 in addition to the places where adhesive is used as denoted in the drawings. Furthermore, adhesive may be used to secure the lower filter frame portion 419 to the pleat tips of the filter medium on its lower face, in addition to the places where adhesive is used as denoted in the drawings.

There are multiple options to manufacture the present invention. Preferably, the filter frame may be made from a single die cut material. Alternatively, the filter frame may be made from a continuous die cut mesh. The corners of the frame may be enhanced with fold over tabs from either or both of the pleat-lock strips and the filter frame

Certain modifications and improvements will occur to those skilled in the art upon a reading of the foregoing description. All modifications and improvements have been deleted herein for the sake of conciseness and readability but are properly within the scope of the following claims.

What is claimed is:

1. A filter comprising:
a. a rectangular pleated filter medium panel having a top face, a bottom face, pleats, a pleating direction, and two sides in the pleating direction and two sides perpendicular to the pleating direction;
b. at least two pleat-lock strips;
c. at least one filter frame having at least two foldable sides, a filter facing face, and a non-filter facing face;
d. wherein each pleat-lock strip is attached to the filter medium panel in the pleating direction;
e. wherein the at least two foldable sides of the filter frame surround at least two sides of the filter medium panel.

2. The filter of claim 1, wherein the pleat-lock strips further comprises an upper face, a side face, and a lower face and wherein the upper faces of the pleat-lock strips abut the top face of the filter medium panel and the lower faces of the pleat-lock strips abut the bottom face of the filter medium panel.

3. The filter of claim 1, wherein the pleat-lock strips are attached to the filter medium panel near the pleating direction sides of the filter medium panel.

4. The filter of claim 1, wherein the pleat-lock strips are attached to the filter medium panel away from the pleating direction sides of the filter medium panel.

5. The filter of claim 1, wherein the at least one filter frame has two foldable sides.

6. The filter of claim 1, wherein the at least one filter frame has four foldable sides.

7. The filter of claim 1, wherein the at least one filter frame are two filter frames, each filter frame placed on opposite sides of the filter medium panel.

8. The filter of claim 1, wherein the pleat-lock strips are attached to the filter medium panel with adhesive.

9. The filter of claim 1, wherein the at least one filter frame has adhesive on the at least one filter frame's filter facing face.

10. The filter of claim 1, wherein the filter frame is webbed.

11. The filter of claim 1, wherein the pleat-lock strips are attached to the filter medium panel such that the pleats of the filter medium panel are held in place to prevent shifting of the pleats in pleating direction.

12. The filter of claim 11, wherein the pleats have a distance between each pleat and the pleat-lock strips are attached to the filter medium panel such that the distance between each pleat is approximately equivalent.
